(19) United States
(12) Patent Application Publication
(10) Pub. No.: US 2002/0111914 A1
(43) Pub. Date: Aug. 15, 2002

(54) Method for specifying product delivery destinations

(76) Inventors: Shuji Terada, Kawasaki (JP); Hideo Noyama, Sagamihara (JP); Takeshi Matsuki, Musashino (JP); Hiroyuki Kojima, Yokohama (JP); Ryusuke Ikegami, Tokyo (JP); Mitsuhiro Hirano, Yokohama (JP); Mitsuru Iwamura, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/060,371

(22) Filed: Feb. 1, 2002

Related U.S. Application Data
(63) Continuation-in-part of application No. 09/653,185, filed on Aug. 31, 2000.

(30) Foreign Application Priority Data
Nov. 22, 2001 (JP) 2001-356857

(51) Int. Cl. G06F 17/60

(52) U.S. Cl. 705/60

(57) ABSTRACT

The present invention discloses a technology for providing a method in on-line shopping and the like that allows products to be delivered efficiently and with no delivery errors to intermediary establishments, e.g., convenience stores, where packages can be picked up at a location other than a user's home address. A computer is set up to mediate delivery and receives a user selection via a network regarding whether a product is to be shipped to the user's home or to another site. If another site is selected, a map of the area showing potential destinations is displayed, and the recipient makes a selection from the map. Special offers available when the package is picked up at a site are also displayed. When the recipient specifies a delivery destination, a coupon containing a recipient authentication certificate and special offers is issued. At manned intermediary establishments, the recipient authentication certification information provided by the recipient is compared with information sent from the computer and the package is handed over to the recipient if the two match. At unmanned locker facilities, an evaluation is made as to whether the pick-up is within the reserved period. If the period has been exceeded, an additional fee is charged. Recipient authentication is then performed, and the box is opened if this is successful.

### CROSS REFERENCE TO RELATED APPLICATION

This is a continuation-in-part of U.S. patent application Ser. No. 09/653,185 filed Aug. 31, 2000, the contents of which are incorporated herein by reference.

### BACKGROUND OF THE INVENTION

The present invention relates to a method for providing a service for delivering a package to a site. More specifically, the present invention provides a method suited for efficiently implementing a method for specifying a package destination site that allows products to be received at a site other than the customer's home.

Japanese laid-open patent publication number 2000-92900 describes a package delivery method conventional package delivery method in which a convenience store receives a package in place of the customer, thus reducing the chances that the delivery service will have to bring back the product. The package recipient leaves a message at the doorbell indicating that the package can be delivered to a convenience store if no one is home. If the package recipient is not home and this type of indication is found, the delivery service leaves a ticket indicating that the package will be delivered to a convenience store. The package is then delivered to the convenience store and the recipient can see the ticket and pick up the package at the convenience store.

When a package is delivered to another site, a package receipt confirmation is needed to pick up the product. Japanese laid-open patent publication number Hei 11-222305 discloses a method for this. In this example, a network connects a distribution management center, a delivery service, and a pick-up site. An information 1 is encrypted to form an information 2, which is attached to a label on the package. The delivery service and the pick-up site reads this label, decodes the information 2, and sends the resulting information 3 to the distribution management center 3. The distribution management center compares the information 1 and the information 3 and confirms that the product was received at the pick-up site if these match.

### SUMMARY OF THE INVENTION

In the conventional technologies described above, the present inventors found that the following issues needed to be addressed. In Japanese laid-open patent publication number 2000-92900, the recipient is able to use the intermediary establishment so that the product can be picked up regardless of the operating hours of the distribution service. Also, the distribution service does not need to attempt re-delivery each time the recipient is not home. However, the distribution service must request the intermediary establishment to receive packages and must pay service fees to the intermediary establishment for the holding of packages and the like. Thus, while being able to eliminate multiple delivery attempts, the distribution service has a harder time making a profit.

The distribution service visits each recipient's home and delivers to a convenience store if the recipient is not home. Thus, each time a package cannot be delivered, the delivery route must be reexamined since a convenience store for holding the package must be selected and added each time. Thus, the work required by the distribution service is not necessarily reduced.

In the technology described in Japanese laid-open patent publication number Hei 11-222305, a network connects the distribution management center, the delivery service, and the pick-up site. An encrypted barcode attached to each package is read at the pick-up site, where it is decoded and checked with the distribution management center. Thus, the location of the package can be determined at any time. This is useful for cases when multiple distribution services are involved in relaying packages. However, this method involves confirmation to be performed at the distribution management center, requiring all pick-up sites and centers to be connected to a network. As a result, the pick-up sites are restricted to sites that can handle a certain minimum distribution volume. Also, since receipt confirmation is performed by sending information read from barcodes to a center, there is no safeguard against intentionally improper operations performed at a pick-up site. Thus, introduction of this technology for pick-up sites that are not part of a chain-store system is difficult.

The present invention was developed to address the issues described above. A first object of the present invention is to provide a method that allows a distribution service to know ahead of time whether a recipient will receive a package at home or at an intermediary establishment.

A second object of the present invention is to provide a system that allows confirmation of the package recipient even for stores that do not have an adequate network environment due to the small volume of packages handled and locker facilities and the like where connection to a center is difficult due to the need for real-time responses.

A third object of the present invention is to provide a system for on-line shopping that allows recipients to indicate a pick-up site other than the home address for delivery of packages.

A fourth object of the present invention is to provide a system that prevents improper acts from being performed at package pick-up sites, thus allowing more establishments to be used as pick-up sites.

A fifth object of the present invention is to provide a system, especially for unmanned pick-up sites such as electronic locker facilities, in which delays in the pick-up operation are minimized.

A sixth object of the present invention is to provide a recipient confirmation for any site and a package delivery method that allows the sender or the sending site to confirm proper delivery of the package to the recipient.

In order to achieve these objects, the following architecture is used. In a system wherein a network connects a user terminal and a distribution intermediary system, a method for specifying a delivery destination site for a product requested by the user is provided. The terminal receives input from the user for selecting whether a delivery destination for a product to be delivered is to be at a home address or at a site other than the home address. The display used for this can involve a display of a map of the area and allowing the user to make a selection. Alternatively, a simple list format can be used. In terms of convenience for the user (recipient), a GUI involving a map display or the like would be preferable. If the user selects a site other than the home address, the distribution intermediary system uses electronic mail to send the user terminal pick-up confirmation information containing a package arrive date and a latest package pick-up date. This terminal can be the terminal handling the selection or can be a different terminal. A separate portable phone or PDA (Personal Digital Assistant) or the like can also be used. The electronic mail notification can include the package order number, the product name, the order date (shipping order date), the pick-up location, the package arrival date, the package holding period, and an indication that an additional fee will be charged if the package pick-up date passes a fixed period.

According to another aspect of the invention, the objects described above are achieved with the following architecture. A service providing method uses a first computer and a second computer connected to a network. The first computer at an originating site of a package generates an identification number to be attached to the package to be shipped. The identification number is sent to the user. A hash function is applied to the identification number to generate a hash value 1, which is then encrypted with a private key to generate an encrypted value 1. A password indicated by the user is added to the encrypted value 1 to generate an encrypted value 2. The encrypted value 2 is printed on the shipping label. The package and the encrypted value 2 are shipped to the destination site.

The second computer at the shipping destination reads the encrypted value 2 attached to the package, subtracts the password brought by the user, and decrypts with a public key. The second computer includes recipient confirming means that applies the hash function to the identification number brought by the user and generates a hash value 2. The decrypted value and the hash value 2 are compared. If the two values match, the person is assumed to be the correct user (recipient), and the package is handed over.

The first computer can also include storing means storing the generated encrypted value 2 and communication means for sending this to the second computer. The second computer can include storing means storing the identification number and the encrypted value 2 and calculating means using an identification number brought by the user as a key to extract the associated encrypted value 2 from storing means. In order to achieve the objects described above, the present invention can also be a program implementing the functions described above or a storage medium storing such a program.

With the architectures described above, any number of people can be going in and out of the intermediary establishment, but package hand-over errors can be prevented since correct recipient authentication is provided. Furthermore, stand-alone operation is possible if encrypted data and the like are sent ahead of time. Thus, unmanned sites such as locker facilities can be used for pick-up.

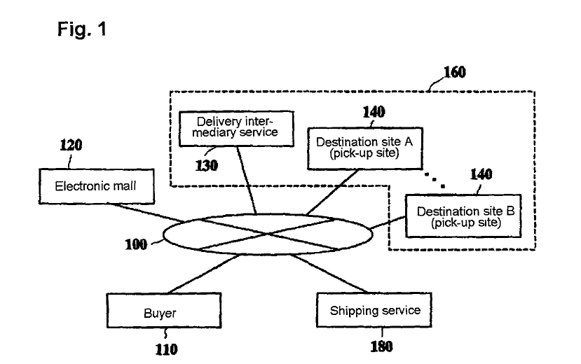

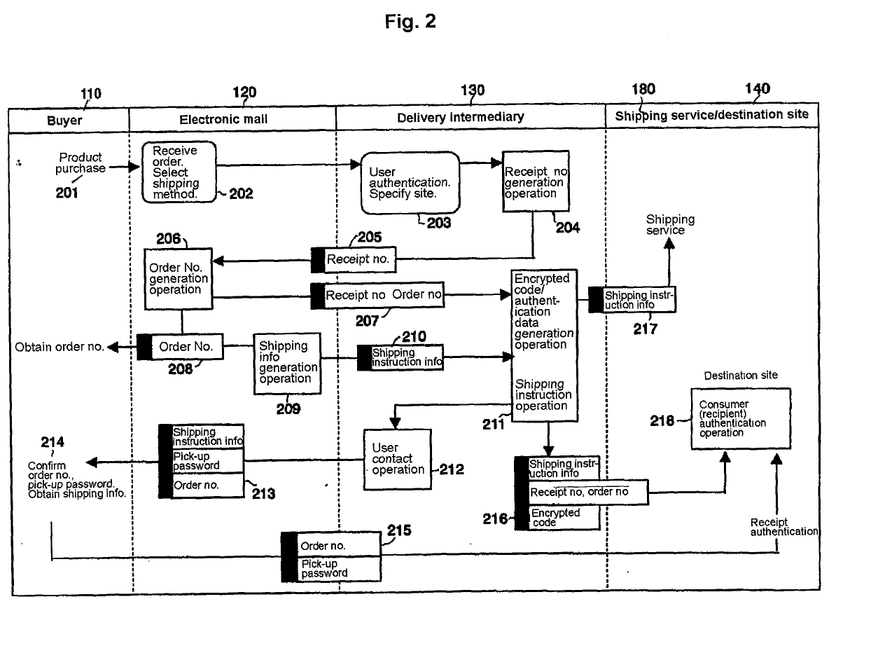

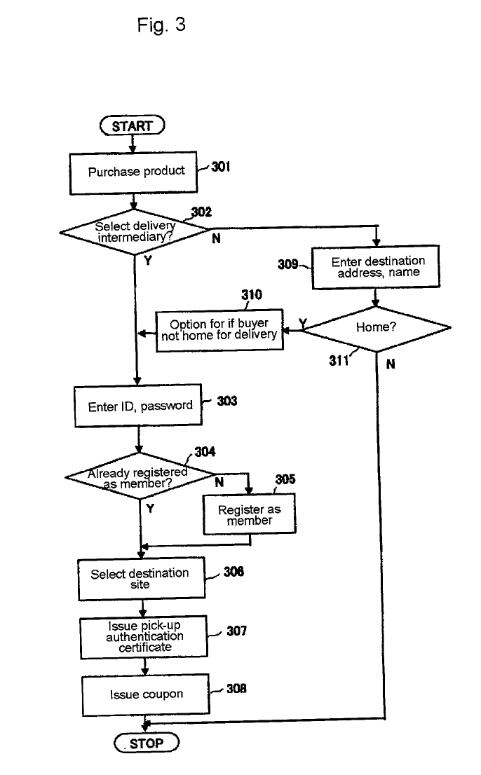

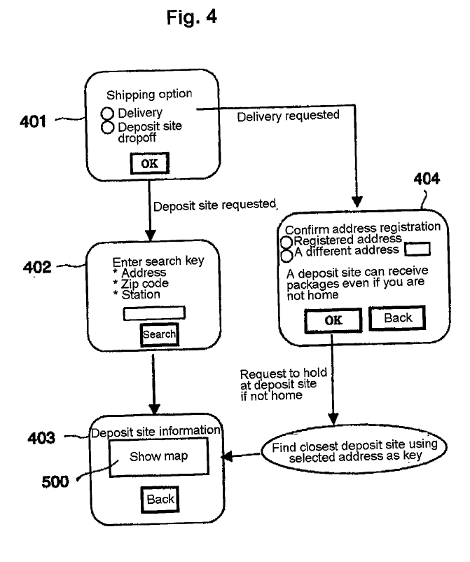

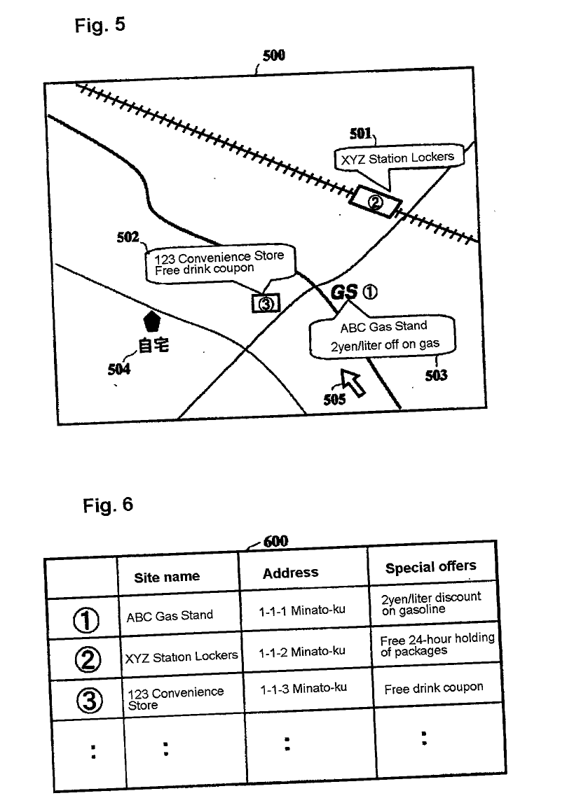

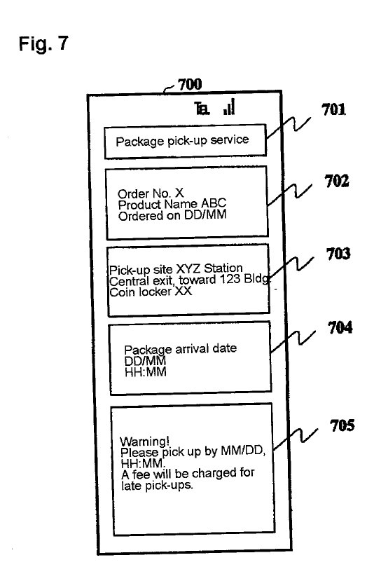

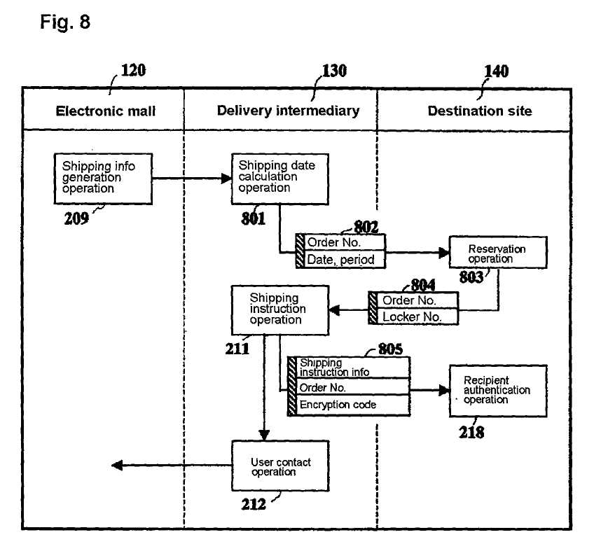

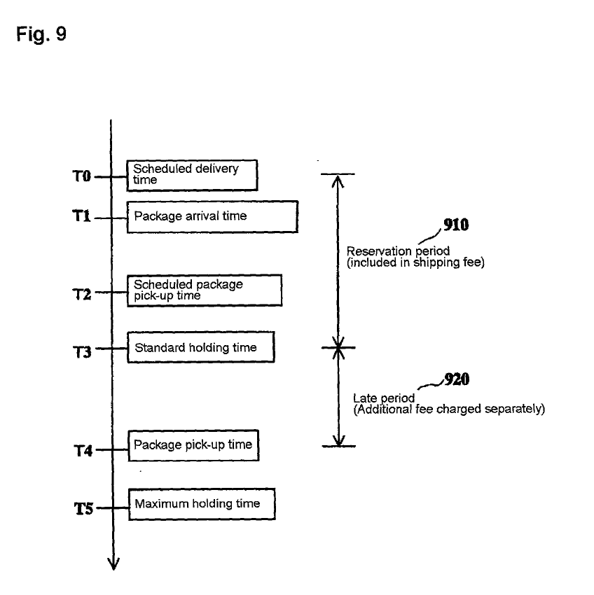

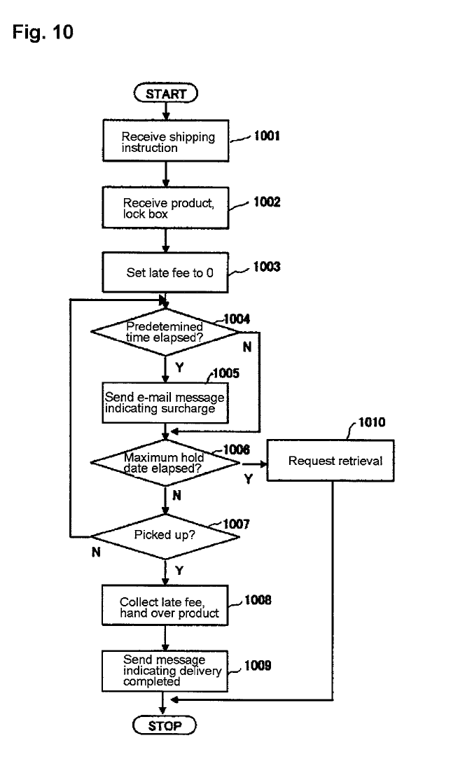

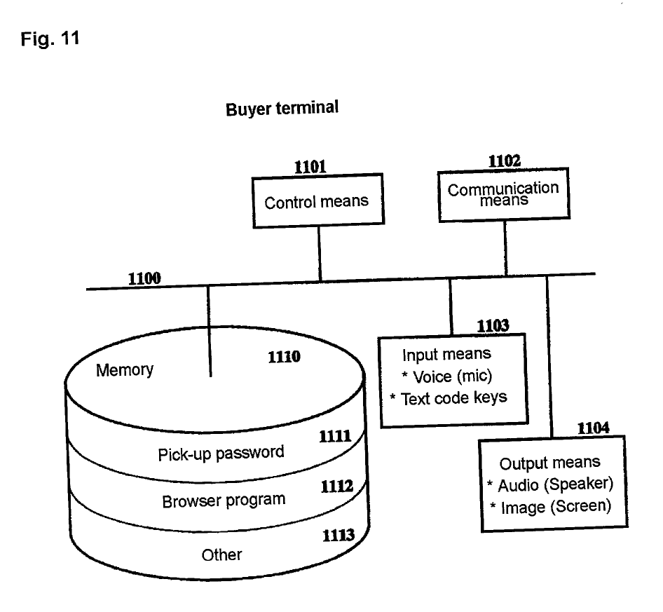

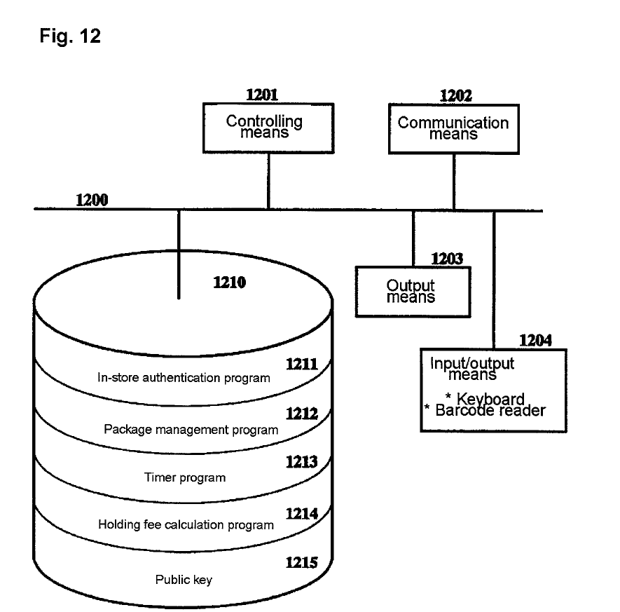

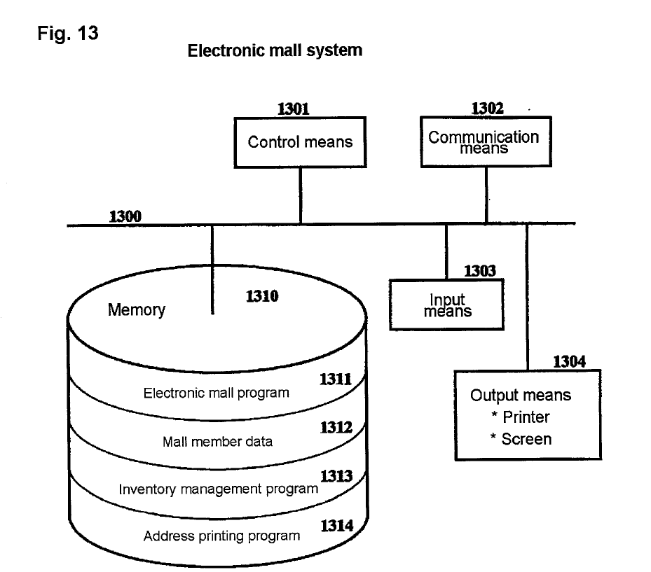

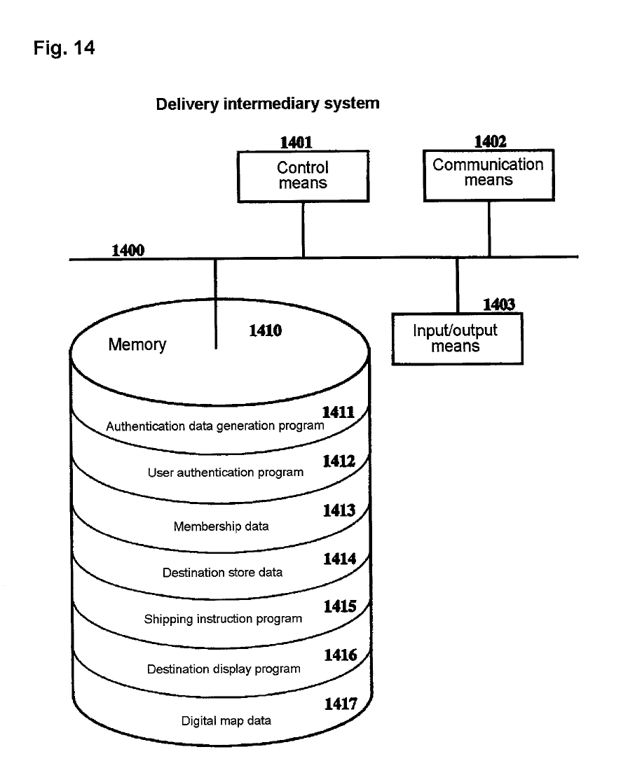

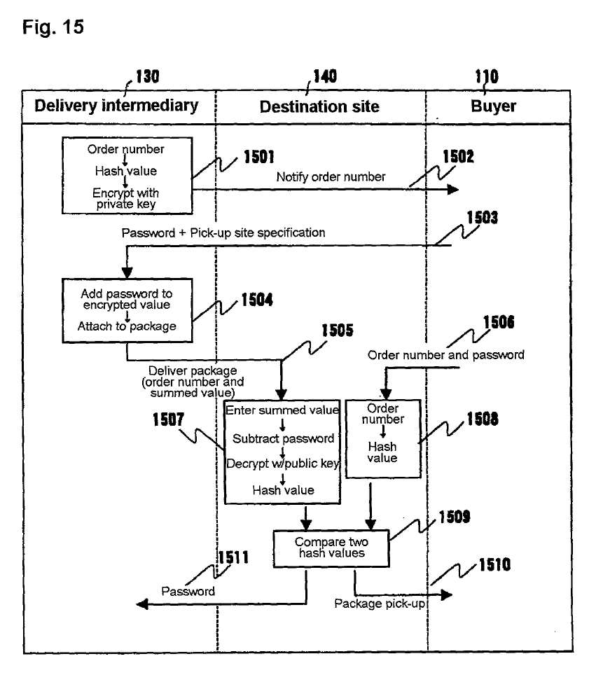

### BRIEF DESCRIPTION OF THE DRAWINGS

[FIG. 1] A drawing for the purpose of describing an overview of a package pick-up service.

[FIG. 2] A drawing for the purpose of describing the overall flow of operations performed in the service shown in FIG. 1.

[FIG. 3] A flowchart showing the operations performed by a computer to determine a delivery destination in FIG. 2.

[FIG. 4] A drawing for the purpose of describing a screen display for determining a delivery destination.

[FIG. 5] A drawing for the purpose of describing a screen display showing potential delivery destination sites.

[FIG. 6] A table showing detailed information about potential delivery destination sites.

[FIG. 7] A drawing showing the structure of an electronic mail message sent to a portable telephone of a buyer.

[FIG. 8] A drawing showing the operations that are different from the ones performed at a store if a locker facility is used as the delivery destination.

[FIG. 9] A drawing for the purpose of describing the operations performed to reserve a locker.

[FIG. 10] A flowchart for calculating additional fees in an electronic locker system.

[FIG. 11] A drawing showing the architecture of a user terminal.

[FIG. 12] A drawing showing the architecture of a destination shop system.

[FIG. 13] A drawing showing the architecture of an electronic mall system.

[FIG. 14] A drawing showing the architecture of a delivery intermediary service system.

[FIG. 15] A flowchart for the purpose of describing encryption operations and authentication operations performed in the present invention.

### PREFERRED EMBODIMENTS OF THE INVENTION

The embodiments of the present invention will be described in detail.

FIG. 1 is a drawing for the purpose of describing a service for delivering products. A network 100 connects a buyer 110, an electronic mall 120, a distribution intermediary 130 managing delivery of products purchased at the electronic mall 120, delivery destination sites A, B, . . . , 140 to which products are delivered, and a computer used at a shipping service 180. The distribution intermediary 130, which is the key element in the service of the present invention, sets up agreements with multiple delivery destination sites 140 to form a distribution franchise 160. In the actual service, there are no restrictions on who operates what, e.g., the distribution intermediary 130 can operate the on-line shopping mall, and the shipping service 180 can be operated as a part of the service. The important point is that multiple delivery destination sites are set up beforehand and indicated as candidates from which a selection is to be made. Pick-up sites or delivery destination sites are selected ahead of time for this. FIG. 1 shows just one shipping service 180, but multiple services can be included. Essentially, any number of service providers that can deliver a package indicated by the delivery intermediary to an indicated destination can be used. It would be desirable for the buyer 110 to be registered to the franchise 160 ahead of time as a user so that an ID and an authentication password can be set up beforehand. The reason for registering users ahead of time is that unless there is a certain degree of identity confirmation beforehand it would be possible for a user to maliciously send a package to a destination. Also, if the e-mail address of the user is registered in a computer at the distribution intermediary 130, services besides the delivery packages can be provided, e.g., sending delivery confirmation notices and pick-up slips to the buyer 110 via e-mail.

FIG. 2 is a drawing for the purpose of describing the overall flow of operations performed in the service shown in FIG. 1. First, the buyer 110 uses a widely known method involving an electronic mall to perform a purchase operation 202 for a product via a network 100, e.g., the Internet. The electronic mall 120 receives the order and a delivery option from the buyer 110 (202). The delivery option includes information such as a pick-up site, time and date, and the like. Details of this will be described later with reference to FIG. 4.

If the buyer 110 selects delivery via a distribution intermediary 130 according to the present invention, information received from the user is sent to the distribution intermediary 130. After performing user confirmation using the user ID and the authentication password registered ahead of time, the distribution intermediary 130 receives the destination information (203). Next, after the necessary information has been entered, a receipt number is created (204), and a receipt number 205 is sent to the electronic mall 120. The electronic mall 120 generates an order number that serves as an identification number for the delivery of the product from the warehouse to a destination 140 (206). The receipt number and the order number 207 are sent to the distribution intermediary 130 via the network 100. The generated order number is also sent via the network 100 to the buyer 110 attached to a widely known order confirmation ticket (not shown in the figure). Based on the order number 208, the electronic mall 120 generates shipping instruction information 210 indicating instructions for shipping the product from the warehouse to the destination. These shipping instructions can be provided by printing out a shipping order form or a package label that includes the sent information.

The distribution intermediary 130 uses the information 207, 210 and generates an encrypted code, authentication data, and shipping instruction information (211). This information is sent to the specified destination 140 via the network 100 (216). Also, the shipping instruction information 217 is sent to the relevant shipping service 180.

The distribution intermediary 130 notifies the user via the network 100 regarding the shipping instruction information, the pick-up password, and the order number (213)>The buyer 110 receives this information and, on or after the specified date, enters the order number and the pick-up password in a terminal device of the destination 140. The destination 140 compares the information received ahead of time (216) with the information entered by the recipient and hands over the product if the information matches (218). A pick-up password can be issued for each product or the authentication password used for user authentication can be used as the pick-up password. Alternatively, a combination (the authentication password + digits from the product identification code) can be used.

Next, the series of operations performed at 202, 203, and 204 from FIG. 2 will be described using FIG. 3 and FIG. 4. FIG. 3 is a flowchart showing the operations performed by computers of the electronic mall 120 and the distribution intermediary 130 based on information entered from the computer of the buyer 110.

First, using an Internet browser application to access the electronic mall 120, the buyer 110 selects a target product and performs purchase operations (step 301). The selection of the product can involve methods widely known in the art. The buyer 110 selects a delivery method In this case, the delivery method for the purchased product is selected either as a method using a delivery service or a method using a distribution intermediary 130 according to the present invention (step 302). FIG. 4 shows a computer screen displayed to the buyer 110 when making this selection. A screen 401 indicates the option for picking up the package at pick-up site as “Pick up at deposit site”.

If deposit site pick-up, i.e., delivery via a delivery intermediary, is selected at step 302, control proceeds to step 303. Otherwise, delivery will be performed using a standard delivery service, so the necessary information such as the destination address, name, and telephone number are entered (step 309). Step 311 determines whether the destination is the buyer's home and, if so, asks whether the buyer wants the package to be delivered to the destination site 140 is the buyer is not home (step 311, 310). If a deposit site is to be used, control proceeds to step 303.

At step 303, the buyer is asked to enter a user ID and password to see if the user has been registered as a member (step 304). The entry screen for step 303 can be displayed within the display screen (web screen) for the electronic mall 120. This allows the buyer 110 to enter the information without being conscious of the fact that the buyer 110 is actually connected to the computer at the distribution intermediary 130. Next, whether or not the buyer 110 has been registered as a member is checked. If not, member registration operations are performed (step 304, 305). Next, the buyer 110 indicates a delivery destination (step 306). In FIG. 4, 402 and 403 illustrate the procedures for processing the delivery destination.

At 402 in FIG. 4, a list of potential destinations 140 is obtained by entering a search key, e.g., a home address, zip code, telephone area code, closest train station, or the like. Then, at 403, a map or list showing the potential sites is displayed. FIG. 5 shows how this map is displayed. FIG. 6 shows a list.

FIG. 5 shows an example in which a home address has been selected as the key, and a map showing a home 504 and closest delivery destination candidates is displayed. In this example, a package pick-up locker facility 501 at a train station, a convenience store 502, and a gas station 503 are displayed as candidates. The buyer 110 selects a destination using a mouse cursor 505. The locker facility referred to here is an electronic locker system equipped with multiple storage locker boxes that can be opened and closed individually. In this system, the package can be placed in a predetermined locker box beforehand. When the buyer enters code information such as a password, the locker box can be automatically opened and the package can be taken home.

One feature here is that in addition to the destination names, additional services that can be provided when the package is picked up at each site are also displayed. For example, a free drink coupon can be obtained if the package is picked up at the convenience store 502. A 2 yen/liter discount for gasoline is provided at the gas station 503. In the case of the lockers at the train station pick-up site, the package can be picked up free at any time within 24 hours of the scheduled delivery time. Thus, the buyer can obtain various special offers when selecting a destination site. Also, if the destination site is a store, the store can expect customers coming to pick up packages to do shopping as well. While not shown in FIG. 5, additional information (e.g., operating days and hours, parking availability, days on which sales are planned) can also be displayed in a pop-up format.

FIG. 6 is a table associated with the map in FIG. 5 and contains information that cannot be displayed on the map. The table includes addresses and phone numbers of pick-up stores as well as detailed information about special offers and coupons. This table 600 can be displayed at the same time as the map 500 or can be displayed on the computer screen of the buyer 110 by itself. This table only shows store names, addresses, and special offers, but it would also be possible to display other additional information as in the case with FIG. 5.

Returning to FIG. 3, when the destination is selected (step 306), pick-up confirmation information is displayed on the screen (step 307) and a coupon as described above is issued (step 110). The buyer 110 can print out the pick-up confirmation information to use as a pick-up slip.

Once the product purchase and delivery destination instruction operations shown in FIG. 3 have been completed, the operations performed by the buyer 110 are finished. Subsequently, when the shipping instruction information 217 is sent to the shipping service 180 and the delivery date is determined, the distribution intermediary 130 sends the buyer e-mail or the like to indicate the delivery schedule.

FIG. 7 shows an example of a notification message sent to a buyer's portable phone (a portable terminal with an e-mail receiving feature). An e-mail message contains: a region 701 indicating the name of the service; a region 702 indicating the information used to identify the ordered product; a region 703 indicating a detailed description of the specified pick-up site; a region 704 indicating the time at which the product can be picked up (i.e., the scheduled package delivery time); and a region 705 indicating special notes and coupon information.

For example, if the pick-up site is a train station locker facility, the region 703 would need to include a detailed description of the location of the locker facility. If multiple locker facilities are located close to each other, information used to identify the proper location would also be needed. In this case, a link is formed at predetermined characters in the region 703 so that when the link is clicked a more detailed map or visual information is displayed to indicate where the lockers are at. In the region 705, information regarding the period at which the package can be picked up for free is important. An indication that an extra fee will be required if the period is exceeded should be included. While not shown in the figure, the region can also include the maximum holding period (the maximum period during which a locker box can be reserved by paying the extra fee).

FIG. 8 shows the changes to the operations shown in FIG. 2 when the destination is a locker facility. When the shipping information generation operation 209 is performed by the electronic mall 120, a delivery date calculation operation 801 is executed at the distribution intermediary 130 to determine the scheduled delivery date and the package holding period. Then, information 802, including the order number, the scheduled delivery date, and the holding period, are sent to the destination site 140.

The destination site 140 performs locker reservation operation 803 based on the information 803. In general, locker facilities start their clocks at midnight for holding periods. Thus, if there are two reservations in the information 802, at midnight two boxes are set up to be in use. Thus, by reserving locker boxes during times they are not used, boxes will always be available when the delivery service delivers packages.

When the reservation is made at the destination site, information 804, containing an order number and a locker number (an identification number for the locker facility or an identification number for a box), is sent back to the distribution intermediary 130. Then, the delivery intermediary performs a shipping instruction operation 211 and requests the electronic mall to contact the buyer 110 (step 212) and sends the delivery destination site information 805 needed for a recipient authentication operation 218.

FIG. 9 is a timechart illustrating the delivery date calculation operation 801. An operation for determining a locker box reservation time sets up: a date and time T1 (package receiving date) at which the package will be delivered to the locker box; and a period T2 (package pick-up schedule) during which the package should be picked up. Since the time T1 can vary somewhat due to traffic conditions and the like, a time slightly earlier than T1 is set up as a scheduled delivery time T0. Also, a standard holding T3 during which items can be picked up without being charged an extra fee is set to a time later than the time T2. A locker reservation period 910 is set up from T0 to T3, with no additional fees being charged if the package is picked up during this period.

If the recipient does not pick up the package within the period T3 and instead comes to pick up the package at a time T4, a late period 920 is set up as the period from the time T3 to the time T4 and additional fees are charged according to the length of this late period. Payment can be made by having the locker device calculate the fee, which the recipient pays by cash. Also, the center can calculate the fee and charge a credit card, or some other accounting method can be used. The recipient can receive the package once this late fee is paid to the locker facility. If a maximum holding date T5 is exceeded, the package can be returned to the sender. By setting up this type of system, the locker facility can be used efficiently even if there is a buyer 110 who does not come to pick up packages.

While not shown in the figure, the locker facility at the pick-up site is equipped with a keyboard for the recipient to enter a pick-up password. With the password, along with the order number, the locker facility compares a hash value generated from a code sent ahead of time and a hash value generated from the entered order number. If there is a match, the legitimacy of the recipient is confirmed and the package is passed on to the recipient. The distribution intermediary can confirm that the recipient has picked up the package by retrieving information indicating that the package has been handed over.

FIG. 10 is a flowchart showing the operations performed by the electronic locker system when calculating additional fees. When the electronic locker system receives the shipping instruction information 216, a locker box to place the product is determined and the locker box reservation time is set up as the period from T0 through T4 described above (step 1001). When the shipping service 180 deposits the product in the specified locker box of the locker facility, the box is locked (step 1002). Next, the electronic locker system initializes a counter for additional fees by setting the counter to 0 (step 1003). If a predetermined period elapses, i.e., if the standard holding time T3 is exceeded, additional fees are added. These fees can be added hourly, daily, or by some other method. When adding to the fee, a notification e-mail message can be sent to the buyer 110, as shown in FIG. 7 (step 1005). Next, when the maximum holding time T5 is exceeded, the delivery service is asked to take the product back for return to the electronic mall 120 (step 1006, step 1020). If the maximum holding time T5 is not reached and no pick-up has taken place, control returns to step 1004 (step 1007).

When the buyer 110 comes to pick up the product, the operation shown in FIG. 15, described later, is performed for identity confirmation, and then the additional fees are calculated. If there is no additional fee, the locker is immediately opened. If there are fees, payment is received and the locker is opened (step 1008). When the product has been handed over, the electronic locker system contacts the distribution intermediary 130 indicating this (step 1009).

Next, the architectures of the systems in FIG. 1 will be described using FIG. 11 through FIG. 14. FIG. 11 shows the architecture of a computer terminal used by the buyer 110. FIG. 12 shows the architecture of a computer system used by the destination site 140. FIG. 13 shows the architecture of the computer system used by the electronic mall 120. FIG. 14 shows the architecture of the computer system used by the distribution intermediary 130.

In FIG. 11, the terminal of the buyer 110 includes: control means 1101 for operating an Internet browser and an e-mail program; communication means 1102 for accessing the Internet; input means 1103 for entering voice or characters; output means 1104 for outputting voice or images; and a memory 1110. These elements are connected by a communication bus 1100. A pick-up password 1111, a browser program 1112, an e-mail program 1113, and the like are stored in the memory 1110.

In FIG. 12, the computer system of the destination site 140 includes: input means 1204 to allow the buyer (recipient) to enter a password; output means 1203 for printing package management information; control means 1201 for performing operations such as performing public key decryption of an encrypted value; communication means 1202 for accessing the Internet; and a memory 1201. These elements are connected by a communication bus 1200. The memory 1210 contains: an on-site authentication program 1211 to determine whether the person coming to pick up a package is the correct recipient; a package management program 1212 for managing packages delivered by the shipping service 180; a timer program [?1213?] for managing late periods exceeding holding times and the like; and a holding fee calculation program 1214 for calculating additional fees resulting from late pick-ups.

In FIG. 13, the computer system used by the electronic mall 120 includes: control means 1301 for operating an electronic mall program; communication means 1302 for accessing the Internet; input means 1303 for entering membership data and inventory data; output means 1304 for package names and addresses; and a memory 1310. These elements are connected by a communication bus 1300. The memory 1310 includes: an electronic mall program 1311; a mall membership data 1312; an inventory management program 1313; a name printing program 1314; and the like.

The computer system of the distribution intermediary 130 includes: control means 1401 for applying a hash function to and encrypting an order number; communication means 1402 for connecting to a network; input/output means 1403 for registering destination site and membership information as well as printing documents for their management; and a memory 1410. These are connected by a communication bus 1400. The memory 1410 contains: an authentication data generation program 1411 for generating encrypted data; a user authentication program 1412 for checking whether a user accessing from the Internet is a member or not; membership data 1413; delivery destination site data 1414; a shipping instruction program 1415 for instructing an electronic mall, a delivery service, or the like on shipping operations; a destination site displaying program for displaying a map overlaid with destination site data when a buyer is selecting a destination site; and digital map data 1417.

Finally, the flowchart in FIG. 15 will be used to describe the operations performed for encryption and authentication in this embodiment. At step 1501, the distribution intermediary 130 applies a hash function to an order number to generate a hash value (H1). This hash value (H1) is encrypted using a private key belonging to the distribution intermediary, resulting in an encrypted value (E(H1)). The distribution intermediary 130 sends the order number to the buyer (recipient) 110 (1502). The buyer 110 specifies and sends a pick-up site and a pick-up password (P1). This password (P1) is unrelated to the order number and can be any value that can be easily remembered by the recipient. Since this password needs to be used only once (one-time password), it can be different from the ID registration password used by the buyer 110.

The distribution intermediary 130 generates encrypted data to be included in the shipping label. More specifically, the password (P1) is added to the encrypted value (E(H1) to generate an encrypted value (E(H1)+P1). This encrypted value (E(H1)+P1) is printed on the shipping label (step 1504). An addition operation is performed in this example, but other operations can be used as long as there is a one-to-one correlation between the input and the output. At step 1505, the package, along with the encrypted value (E(H1)+P1) and the order number, are shipped to the destination site 140.

At step 1507, the destination site 140 reads the encrypted value (E(H1)+P1) from the package tag and subtracts the password (P1) brought in by the recipient to generate the encrypted value (E(H1)). This is then decrypted using a public key belonging to the distribution intermediary 130. This results in a hash value (H3). At step 1506, the destination site 140 received the password and order number brought in by the recipient, and a hash function is applied to this order number at step 1508 to generate a hash value (H2). At step 1509, this hash value (H2) and the hash value (H3) are compared. If the two values match, the person is determined to be the correct buyer (recipient), and the handing over of the package is allowed at step 1510.

Furthermore, the destination site 140 stores the password (P1) used by the buyer and sends this password (P1) to the distribution intermediary 130 in place of a package delivery receipt. The destination site 140 has the public key of the distribution intermediary 130 but cannot correctly decode without the password. Thus, the distribution intermediary 130 has the delivery destination and the password (P1) for each order number and can confirm that the package was handed over to the buyer 110 by retrieving this information from the destination site 140.

With the implementation of the present invention, an operator of an electronic mall 130 can use an unaffiliated destination site 140 as a pick-up site, thus allowing the buyer to receive services using establishments that are close by.

In this embodiment, the distribution intermediary computer, the electronic mall computer, the destination site computer, and the buyer computer are all personal computers, workstations, or the like, and features of the various means described above are implemented through programs operating on these computers. More specifically, the buyer's computer is not restricted to a “computer” device and can be a multi-function portable terminal, i.e., a portable telephone, equipped with storage means, display means, and input means to run programs.

In the embodiment described above, programs were installed ahead of time in the computer at the destination site. In other words, the pick-up site could not receive these services unless a computer device equipped with special programs was purchased. This forces the involved parties to install special programs.

However, technologies such as Java can be used. Java applets corresponding to the special programs can be set up, and these applets can be downloaded from the service provider's server computer and used by the pick-up center or the like. Thus, the applets can be used by a small storeowner through a general-purpose browser. Since almost all computers connected to a network are installed with a general-purpose browser, the use of Java can eliminate the need for the storeowner to perform special installation operations.

The above was a description of the overview of a service according to an embodiment of the present invention. The distribution intermediary service of this embodiment is not restricted to on-line shopping in electronic malls but can also be applied to standard package delivery services. Also, the embodiment describes the products as being at the electronic mall, but it would also be possible for a user to order using a computer or by phone. Then, once the necessary information has been passed back and forth over a network, a shipping service can go to a warehouse or the like to pick up the package.

With the present invention as described above, a distributor can know ahead of time whether a recipient will receive a package at home or will pick up a package at an intermediary site. For pick-ups at an intermediate site, where any number of people can go in or out, the present invention allows the recipient's identity to be confirmed. Also, the present invention allows package pick-ups to take place at establishments not adequately equipped with a network environment and unmanned pick-up sites such as locker facilities. Thus, the consumer can pick up packages at train stations or gas stands on the way to or from work.

1. In a system wherein a network connects a user terminal and a distribution intermediary system,
a method for specifying a delivery destination site for a product requested by said user wherein:
said terminal receives input from said user for selecting whether a delivery destination for a product to be delivered is to be at a home address or at a site other than said home address; and
if said user selects a site other than said home address, said distribution intermediary system uses electronic mail to send said user terminal pick-up confirmation information containing a package arrive date and a latest package pick-up date.

2. A method for specifying a product delivery destination as described in claim 1 wherein said notification to said user terminal includes notification that an additional fee will be charged if a date at which said product is picked up is past a fixed period.

3. A method for specifying a product delivery destination as described in claim 1 wherein said electronic mail notification is received by a terminal different from said terminal handling said selection.

4. A service providing method using a first computer and a second computer connected to a network wherein said first computer at an originating site of a package: generates an identification number to be attached to said package to be shipped; sends via said network said identification number to said second computer used by a recipient of said package; uses a hash function to convert said identification number to a short value and encrypts said hash value with a private key to generate an encrypted value 1; generates an encrypted value 2 by processing a password known only to said recipient with said encrypted value 1; prints said encrypted value 2 on a ticket and manages said identification number in association with delivery status information for said package; and updates said package delivery status information by receiving said password from said second computer at said package pick-up site.

5. A service providing method as described in claim 4 wherein said second computer: receives said password from said package recipient; reads an encrypted value attached to said package; decrypts said encrypted value; compares said decrypted value with said hash value; and, if said values match, sends said password to said first computer.
